(19) United States
(12) Patent Application Publication
(10) Pub. No.: US 2008/0161184 A1
(43) Pub. Date: Jul. 3, 2008

(54) Photocatalyst composite and fabrication method thereof

(75) Inventors: Yao-Hsuan Tseng, Taoyuan County (TW); Jia-Hung Huang, Hsinchu (TW); Shu-Ling Liu, Mioli County (TW); Yao-Ling Huang, Hsinchu (TW); Chih-Pin Huang, Hsinchu City (TW); Wen-Pin Hsieh, Taichung County (TW)

Correspondence Address: BIRCH STEWART KOLASCH & BIRCH, PO BOX 747, FALLS CHURCH, VA, 22040-0747, US

(73) Assignee: INDUSTRIAL TECHNOLOGY RESEARCH INSTITUTE

(21) Appl. No.: 11/878,109

(22) Filed: Jul. 20, 2007

(30) Foreign Application Priority Data
Dec. 28, 2006 (TW) 95149467

(51) Int. Cl. B01J 37/02; B01J 23/745

(52) U.S. Cl. 502/102; 502/338

(57) ABSTRACT

A photocatalyst composite and fabrication method thereof. The photocatalyst composite of invention comprises a photocatalyst and iron catalyst, wherein the photocatalyst is carried on the surface of the iron catalyst and the ratio of the photocatalyst to the iron catalyst is about 3:100 to 15:100. The photocatalyst composite can be used for water treatment, air treatment and soil remediation.

### BACKGROUND OF THE INVENTION

1. Field of the Invention

The invention relates to catalysts, and in particular to a composition comprising photocatalyst and iron catalyst and a fabrication method thereof.

2. Description of the Related Art

Conventional photocatalyst and iron catalyst are popular in environment purification. A major photocatalyst is titanium dioxide having anatase structure, with a diameter of less than 30 nm. The surface of the titanium dioxide may produce an active species for oxidation-reduction reaction when the photocatalyst is exposed to light with a wavelength of less than 380 nm. In addition, oxygen atoms on the photocatalyst surface are released to form a highly hydrophilic material so that the photocatalyst also has anti-fog and anti-dust properties. The titanium dioxide can be used for removing pollutant, clarification of air, clarification of water, deodorization, and bacteria removal. Iron catalyst is a zero-valence iron, used to remove organic pollutants such as dioxin from the environment, and the pollutant is also decomposed via oxidation-reduction mechanism. Furthermore, the iron catalyst also can remove metal, halogens, and/or organic pollutants from groundwater, soil, and/or water.

Although the photocatalyst can be activated by photoenergy, the reaction rate is slow. The iron catalyst has a higher activity than the photocatalyst, but the activity declines rapidly, resulting in a short lifetime. The photocatalyst, however, is not easily combinable with other catalysts to provide a feasible and recyclable composition. To satisfy different requirements, a photocatalyst composite having a higher activity and longer lifetime is needed.

### BRIEF SUMMARY OF INVENTION

The invention provides a photocatalyst composite comprising a photocatalyst and an iron catalyst, having higher activity and longer lifetime.

In an embodiment, the invention provides a photocatalyst composite, comprising a photocatalyst and an iron catalyst, wherein the photocatalyst is carried on the surface of the iron catalyst and the ratio of the photocatalyst to the iron catalyst is about 3:100 to 15:100.

In another embodiment, the invention provides a method of forming a photocatalyst composite, comprising providing a sol of a photocatalyst, and adding an iron catalyst to the photocatalyst sol such that the photocatalyst is carried on the surface of the iron catalyst to form the photocatalyst composite.

In another embodiment, the invention provides a method of forming a photocatalyst composite, comprising providing a precursor containing a photocatalyst; adding an alkaline solution to the precursor to form a precipitate; adding a peptizing agent to the precipitate to form a peptized precipitate, and adding an inorganic modifier and an iron catalyst to the peptized precipitate to form the photocatalyst composite, wherein the photocatalyst is carried on the surface of the iron catalyst.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows the structure of a photocatalyst composite of the invention.

FIG. 2 is a scanning electron microscopy (SEM) image of the photocatalyst composite of the invention.

FIG. 3 shows X-ray diffraction of the photocatalyst composite (titanium-iron catalyst) of the invention.

FIG. 4 shows the dye removal rate of the photocatalyst composite of the invention; and

FIG. 5a-5b shows total organic carbon (TOC) removal rate and lifetime of the titanium-iron catalyst of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a photocatalyst composite comprising a photocatalyst and an iron catalyst, wherein the photocatalyst is carried on the surface of the iron catalyst. The photocatalyst composite exhibits high activity and long lifetime.

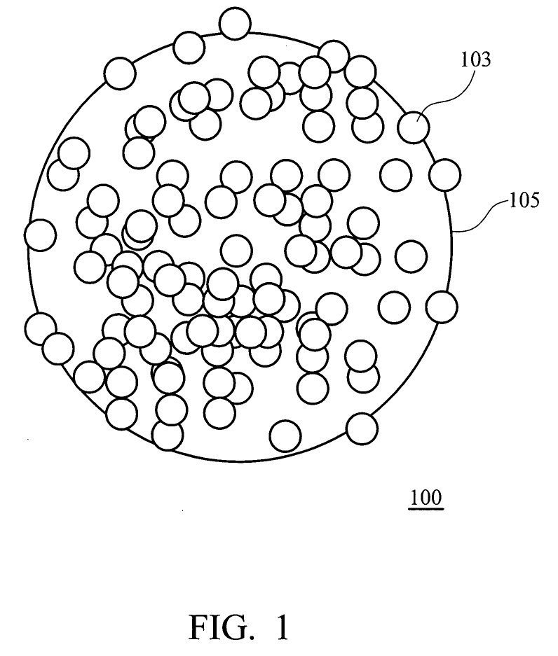

Referring to FIG. 1a, the photocatalyst composite 100 of the invention comprises a photocatalyst 103 and an iron catalyst 105, wherein the photocatalyst 103 is carried on the surface of the iron catalyst 105. The photocatalyst includes titanium dioxide, zinc oxide, stannic oxide, and combinations thereof, and the iron catalyst is zero-valence iron catalyst. The ratio of the photocatalyst to the zero-valence iron catalyst is about 3:100 to 15:100, or about 5:100 to 12:100. The iron catalyst has a diameter between about 5 nm and 100 μm, or about 5 nm and 200 nm. The photocatalyst composite of the invention has a higher total organic carbon (TOC) removal rate and longer lifetime than the conventional catalyst, and can be used for water treatment, air treatment and soil remediation.

The invention also provides a fabrication method for a photocatalyst composite comprising providing a sol of a photocatalyst, and adding an iron catalyst to the sol of the photocatalyst such that the photocatalyst is carried on the surface of the iron catalyst to form the photocatalyst composite. The photocatalyst sol includes titanium dioxide, zinc oxide, stannic oxide, or combinations thereof, and the photocatalyst sol contains about 0.01 to 50 wt % of photocatalyst. The photocatalyst sol and the iron catalyst of the invention are easily accomplished by one of ordinarily skill in the art. For example, the manufacture method of the photocatalyst sol can comprise providing a metal salt containing a photocatalyst, adding an alkaline solution to the metal salt to form a precipitate, adding a peptizing agent to the precipitate to form a peptized precipitate, and adding an inorganic modifier. The fabrication method of the iron catalyst comprises mixing 0.5M sodium borohydride solution and 0.025M Iron(III) chloride-6-hydrate solution to form the zero-valence iron catalyst, and then the zero-valence iron catalyst is dried to form the zero-valence iron granular structure (see Environ. Sci. Technol., 35, 4922-4926).

Next, the zero-valence iron granular structure is added to the photocatalyst sol, and photocatalyst composite of the invention is obtained by stirring, filtering, and drying. The photocatalyst composite can be preserved in a nitrogen oven. The ratio of the photocatalyst to the iron catalyst is about 3:100 to 15:100, or about 5:100 to 12:100. The stirring step is related to the used material. For example, the stirring step is carried out for between about 0.1 and 5 hours, or about 0.2 and 0.5 hours if the titanium dioxide and the zero-valence iron catalyst are used.

In another embodiment, a fabrication method of photocatalyst composite is also provided, comprising providing a precursor containing a photocatalyst, adding an alkaline solution to the precursor to form a precipitate, adding a peptizing agent to the precipitate to form a peptized precipitate, and adding an inorganic modifier and an iron catalyst to the peptized precipitate to form the photocatalyst composite. The photocatalyst includes titanium tetrachloride, zinc oxide, stannic oxide, or titanium sulfate. The pH value of the alkaline solution, such as ammonia or sodium hydroxide, is between 10 and 13. The precipitate includes titanium hydroxide, zinc hydroxide, stannic hydroxide or the like. The peptizing agent includes hydrogen peroxide, nitric acid, saline, or oxalic acid. The inorganic modifier includes the inorganic compound containing silicon, such as colloid silica, TEOS, TMOS, silicate solution, or sodium silicate solution. The characteristic of the invention is adding the iron catalyst, wherein the iron catalyst is a zero-valence iron catalyst.

After the inorganic modifier and the iron catalyst are added to the peptized precipitate, the catalyst composition is obtained by stirring, filtering, and drying. A ratio of the photocatalyst to the iron catalyst is about 3:100 to 15:100, or about 5:100 to 12:100. The stirring step is related to the used material. For example, stirring step can be carried out for between about 0.1 and 5 hours, or about 0.2 and 0.5 hours if the titanium dioxide and the zero-valence iron catalyst are used. The photocatalyst composite then can be preserved in a nitrogen oven.

### EXAMPLE

### Example 1

### The Manufacture of Titanium Dioxide Photocatalyst Sol

20 g of titanium tetrachloride and 250 g of pure water were mixed at 4° C. and stirred until mixed, and then 400 ml of 20% ammonia was added to form a titanium hydroxide precipitate. After stirring for 2 hours, the precipitate was filtrated and washed with pure water to remove chloride. When the chloride concentration of the washed precipitate was lower than 0.001M, 135 ml of 35% hydrogen peroxide and 1.5 L of pure water was added and mixed for 2 hours, and 1% silicon sol was added. After reflux at 90° C. for 8 hours, a photocatalyst sol of the titanium dioxide was formed (see Taiwan patent NO. I230690).

### Example 2

### The Manufacture of Iron Catalyst

0.5M sodium borohydride solution and 0.025M Iron(III) chloride-6-hydrate solution were mixed to form a zero-valence iron precipitant, and then the zero-valence iron precipitant was dried to form the zero-valence iron granular structure (see Environ. Sci. Technol., 35, 4922-4926, Chemosphere., 38(3):565-571, Chemosphere., 38(11):2689-2695).

### Example 3

### The Manufacture of Photocatalyst Composite (TiO₂-Iron Catalyst) (I)

200 ml of the 1 wt % photocatalyst sol and 20 g of the iron catalyst were mixed, stirred for 0.5 hours, and filtrated to form a TiO₂-iron catalyst solution, wherein the ratio of the titanium dioxide to the zero-valence iron was 1:10. The TiO₂-iron catalyst solution was then dried by a nitrogen oven to form the TiO₂-iron catalyst granular structure.

### Example 4

### The Manufacture of Photocatalyst Composite (TiO₂-Iron Catalyst) (II)

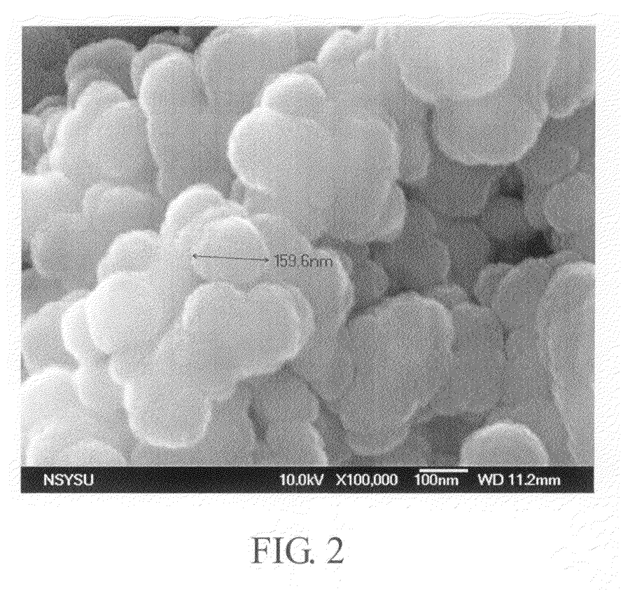

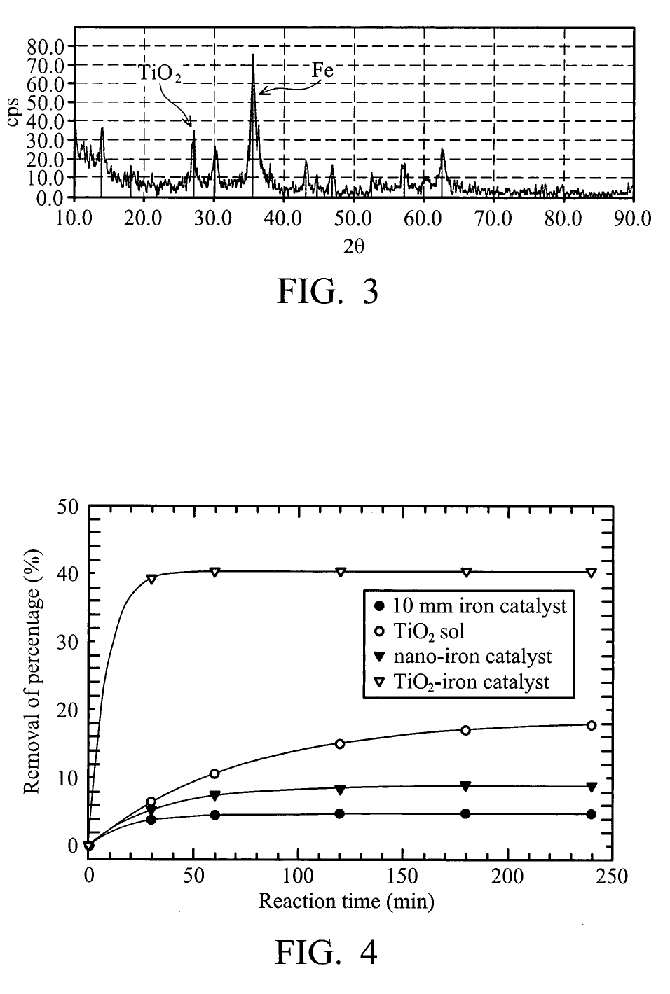

20 g of the iron catalyst was added to the silicon sol in the reflux step of the example 1 for 2 hours of stirring. The TiO₂-iron catalyst solution was obtained by filtration, wherein a ratio of the titanium dioxide to the zero-valence iron was 1:10. The TiO₂-iron catalyst solution then was dried by a nitrogen oven to form the TiO₂-iron catalyst granular structure. FIG. 2 is a scanning electron microscopy (SEM) image of the TiO₂-iron catalyst of the invention. FIG. 3 is an X-ray diffraction of the TiO₂-iron catalyst of the invention, and the FIG. 3 shows the TiO₂-iron catalyst contained the titanium dioxide and the iron simultaneously.

### Example 5

### The Ability of Removing Dye

1 L of 25 mg/L the acid black 24 was treated with 0.2 g of the titanium dioxide, zero-valence iron catalyst, and TiO₂-iron catalyst of the invention respectively for 0 to 240 hours. FIG. 4 shows the removability of the titanium dioxide, zero-valence iron catalyst, and titanium-iron catalyst respectively. Referring to FIG. 4, after treatment for 30 min, the removal rate of the TiO₂-iron catalyst was 40%, but the removal rate of the titanium dioxide and the zero-valence iron catalyst were both less than 20%.

### Example 6

### The Lifetime of the TiO₂-Iron Catalyst

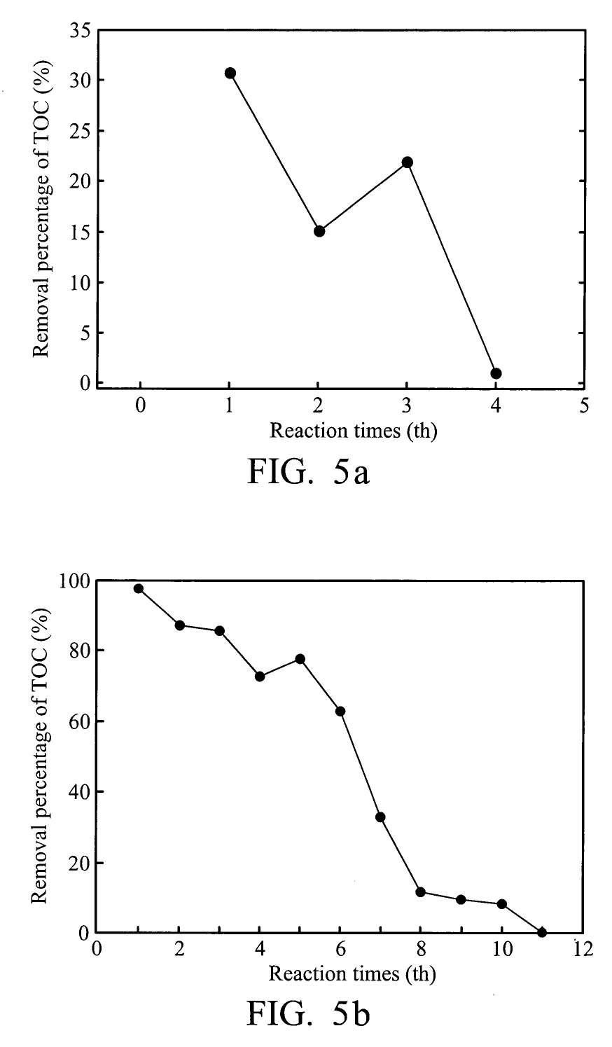

1 L of 25 mg/L the acid black 24 was treated with 5 g of the zero-valence iron catalyst and TiO₂-iron catalyst of the invention, respectively. FIG. 5 shows the total organic carbon (TOC) removal rate and lifetime of the zero-valence iron catalyst, and TiO₂-iron catalyst, respectively. Referring to FIG. 5a-5b, the TOC removal rate of the zero-valence iron catalyst was lower than 30%, and the activity of the zero-valence iron catalyst was lost when used 4 times. However, the TOC removal rate of the TiO₂-iron catalyst was 100%, and the activity of the TiO₂-iron catalyst was lost until use for 11 times.

### Example 7

### The Analysis of the Anti-Oxidation

The treated zero-valence iron catalyst and the treated TiO₂-iron catalyst of the invention were analyzed. First, the zero-valence iron catalyst and the TiO₂-iron catalyst were treated with acid black 24 for 240 hours, respectively, and then the oxidation of the zero-valence iron catalyst and the TiO₂-iron catalyst were assayed by X-ray photoelectron spectroscopy (XPS). The zero-valence iron was found in the zero-valence iron catalyst after the zero-valence iron catalyst was etched by Ar for 3 min. However, the TiO₂-iron catalyst of the invention was etched by Ar for 1 min, the zero-valence iron was found. It is demonstrated that the anti-oxidation ability of the TiO₂-iron catalyst is higher than zero-valence iron catalyst.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A photocatalyst composite, comprising a photocatalyst and an iron catalyst, wherein the photocatalyst is carried on the surface of the iron catalyst and the ratio of the photocatalyst to the iron catalyst is about 3:100 to 15:100.

2. The photocatalyst composite as claimed in claim 1, wherein the photocatalyst comprises titanium dioxide, zinc oxide, stannic oxide, or combinations thereof.

3. The photocatalyst composite as claimed in claim 1, wherein the iron catalyst is zero-valence iron catalyst.

4. The photocatalyst composite as claimed in claim 1, wherein the iron catalyst has a diameter between 5 nm and 100 μm.

5. A method of forming a photocatalyst composite, comprising providing a sol of a photocatalyst, and adding an iron catalyst to the sol such that the photocatalyst is carried on the surface of the iron catalyst to form the photocatalyst composite.

6. The method as claimed in claim 5, wherein the photocatalyst comprises titanium dioxide, zinc oxide, stannic oxide, or combinations thereof.

7. The method as claimed in claim 5 wherein the photocatalyst sol comprises about 0.01 to 50 wt % of the photocatalyst.

8. The method as claimed in claim 5, wherein the iron catalyst is a zero-valence iron catalyst.

9. The method as claimed in claim 5, wherein the iron catalyst has a diameter between about 5 nm and 100 μm.

10. The method as claimed in claim 5, wherein a ratio of the photocatalyst to the iron catalyst is about 3:100 to 15:100.

11. A method of forming a photocatalyst composite, comprising providing a precursor containing a photocatalyst;
adding an alkaline solution to the precursor to form a precipitate;
adding a peptizing agent to the precipitate to form a peptized precipitate, and
adding an inorganic modifier and an iron catalyst to the peptized precipitate to form the photocatalyst composite, wherein the photocatalyst is carried on the surface of the iron catalyst.

12. The method as claimed in claim 11, wherein the precursor comprises titanium tetrachloride, zinc oxide, or stannic oxide.

13. The method as claimed in claim 11, wherein a pH value of the alkaline solution is between 10 and 13.

14. The method as claimed in claim 11, wherein the alkaline solution is ammonia or sodium hydroxide.

15. The method as claimed in claim 11, wherein the precipitate comprises titanium hydroxide, zinc hydroxide, or stannic hydroxide.

16. The method as claimed in claim 11, wherein the peptizing agent comprises hydrogen peroxide, nitric acid, saline, or oxalic acid.

17. The method as claimed in claim 11, wherein the inorganic modifier comprises Si-containing inorganic compounds.

18. The method as claimed in claim 11, wherein the iron catalyst is a zero-valence iron catalyst.

19. The method as claimed in claim 11, wherein the iron catalyst has a diameter between about 5 nm and 100 μm.

20. The method as claimed in claim 11, wherein a ratio of the photocatalyst to the iron catalyst is about 3:100 to 15:100.
